(19) United States
(12) Patent Application Publication
(10) Pub. No.: US 2008/0297433 A1
(43) Pub. Date: Dec. 4, 2008

(54) Secure activation of auxiliary display

(75) Inventors: Zeev Heller, Ganei Tikva (IL); Ilia Stolov, Holon (IL)

Correspondence Address: ABELMAN, FRAYNE & SCHWAB, 666 THIRD AVENUE, 10TH FLOOR, NEW YORK, NY, 10017, US

(73) Assignee: Winbond Electronics Corporation

(21) Appl. No.: 11/807,679

(22) Filed: May 29, 2007

(51) Int. Cl. G09G 5/00

(52) U.S. Cl. 345/2.1

(57) ABSTRACT

A computing apparatus includes a primary keyboard and a primary display, which are respectively arranged to accept input from a user and to display information to the user. An auxiliary display is arranged to display auxiliary information to the user when the apparatus is in a switched-off operational state, and to hide the auxiliary information when deactivated. An activation controller is arranged to monitor the primary keyboard when the auxiliary display is deactivated, to detect an activation code comprising one or more keystrokes entered using the primary keyboard, and to activate the auxiliary display responsively to detecting the activation code.

### FIELD OF THE INVENTION

The present invention relates generally to computer systems, and particularly to methods and systems for operating auxiliary displays.

### BACKGROUND OF THE INVENTION

An auxiliary display is a small-size display, which is connected to a host computer and allows a user to view selected information, even when the host is switched off or hibernating. For example, an auxiliary display can be fitted in the external cover or other external surface of a laptop computer, enabling the user to view e-mail messages, calendar entries, news headlines and other information. Auxiliary information can be viewed when the laptop is switched off or in standby mode, such as when the laptop cover is closed. Some auxiliary display modules also comprise keypads or other input devices, using which the user can interact with the module, such as for scrolling or otherwise manipulating the displayed information.

Windows Sideshow™ is a product family offered by Microsoft Corp. (Redmond, Wash.), which enables a variety of auxiliary display devices to be connected to Windows Vista™ applications. Auxiliary display modules that operate with Windows Sideshow are described, for example, by Fuller in “Auxiliary Display Platform in Longhorn,” Windows Hardware Engineering Conference (WinHEC) 2005, Seattle, Wash., Apr. 25-27, 2005, and by Polivy in “Building Remote and Integrated Auxiliary Display Devices for Windows SideShow,” WinHEC 2006, Seattle, Wash., May 23-25, 2006, which are incorporated herein by reference.

Some aspects of auxiliary display operation are described in the patent literature. For example, U.S. Patent Application Publication 2006/0007051, whose disclosure is incorporated herein by reference, describes a method and system for auxiliary display of information for a computing device. An auxiliary display is integrated with a computing system to provide an area where notifications can be peripherally presented off-screen. Whenever a background task sends a notification to the main display of the system, the notification may be redirected to appear instead on the auxiliary display. The auxiliary display may be placed on the central processor chassis or on the monitor border along with indicator lights to provide simple peripheral-vision notification. By pressing a button, a user may obtain additional detailed follow-up information.

U.S. Patent Application Publication 2005/0243021, whose disclosure is incorporated herein by reference, describes an architecture by which application programs can provide data to auxiliary display devices for display to a user. A defined application layer allows programs to provide data to a service, which controls the output of data to an auxiliary display device and returns navigational data to the application upon appropriate user interaction with the device via actuators. The architecture further provides a protocol layer that allows various types of displays to serve as an auxiliary display.

### SUMMARY OF THE INVENTION

Embodiments of the present invention provide a computing apparatus, including:

a primary keyboard and a primary display, which are respectively arranged to accept input from a user and to display information to the user;

an auxiliary display, which is arranged to display auxiliary information to the user when the apparatus is in a switched-off operational state, and to hide the auxiliary information when deactivated; and

an activation controller, which is arranged to monitor the primary keyboard when the auxiliary display is deactivated, to detect an activation code including one or more keystrokes entered using the primary keyboard, and to activate the auxiliary display responsively to detecting the activation code.

In some embodiments, the apparatus includes an enclosure having an interior and an external surface, the primary keyboard and the primary display are fitted in the interior of the enclosure and the auxiliary display is fitted on the external surface of the enclosure. In an embodiment, the enclosure includes a folding cover, and the auxiliary display is fitted on the external surface of the cover.

In another embodiment, the activation controller is arranged to monitor the primary keyboard irrespective of whether the apparatus is in the switched-off operational state. In yet another embodiment, the apparatus includes a central processing unit (CPU) and an auxiliary display controller, the CPU is arranged to produce the auxiliary information and to provide the auxiliary information to the auxiliary display controller, and the activation controller is arranged to disable the CPU when the apparatus is in the switched-off operational state. In a disclosed embodiment, the activation controller and the auxiliary display controller are arranged to communicate with one another over a communication interface, and the activation controller is arranged to activate the auxiliary display by sending an activation message to the auxiliary display controller over the communication interface. The communication interface may include a System Management Bus (SMBus). The activation code may include an alphanumerical password.

There is additionally provided, in accordance with an embodiment of the present invention, a computing method, including:

in a computer that includes a primary keyboard, a primary display and an auxiliary display, displaying auxiliary information on the auxiliary display when the computer is in a switched-off operational state and hiding the auxiliary information when the auxiliary display is deactivated;

monitoring the primary keyboard when the auxiliary display is deactivated;

detecting an activation code including one or more keystrokes entered using the primary keyboard; and

activating the auxiliary display responsively to detecting the activation code so as to display the auxiliary information.

There is also provided, in accordance with an embodiment of the present invention, a computer software product used in a computer that includes a primary keyboard, a primary display and an auxiliary display, the product including a computer-readable medium, in which program instructions are stored, which instructions, when read by the computer, cause the computer to display auxiliary information on the auxiliary display when the computer is in a switched-off operational state, to hide the auxiliary information when the auxiliary display is deactivated, to monitor the primary keyboard when the auxiliary display is deactivated, to detect an activation code including one or more keystrokes entered using the primary keyboard, and to activate the auxiliary display responsively to detecting the activation code.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a computer that includes an auxiliary display module, in accordance with an embodiment of the present invention;

FIG. 2 is a block diagram that schematically illustrates a computer that includes an auxiliary display module, in accordance with an embodiment of the present invention; and

FIG. 3 is a flow chart that schematically illustrates a method for activation of an auxiliary display module, in accordance with an embodiment of the present invention.

### DETAILED DESCRIPTION OF EMBODIMENTS

### Overview

In some computer configurations, the auxiliary display module is deactivated when not in use in order to reduce the energy consumption of the computer. In some cases, particularly when the auxiliary module is fitted on the outside of the computer, deactivation of the auxiliary module is also used as a security measure, for preventing unauthorized viewing and manipulation of the auxiliary information.

Embodiments of the present invention provide improved methods and systems for re-activating the auxiliary display module in a secure manner, using the primary keyboard of the computer. Typically, the computer comprises an embedded controller, which monitors the primary keyboard regardless of whether the computer is on, off or in standby. In order to activate the auxiliary display module, the user enters a predetermined activation code, which comprises one or more keystrokes, using the primary keyboard. Upon detecting the activation code, the embedded controller activates the auxiliary display module.

In some known activation methods, the user activates the auxiliary display module using a keypad of the auxiliary module itself. Unlike these known methods, the methods and systems described herein provide improved security, since the primary keyboard has a much larger number of keys than the auxiliary keypad. Entering the activation code using the primary keyboard enables the use of activation codes having substantially any length or complexity. Furthermore, when the auxiliary module is mounted on the outside of the computer, activating the module using the internal primary keyboard and not using an external keypad is advantageous, since the module cannot be inadvertently activated by accidental key presses.

### System Description

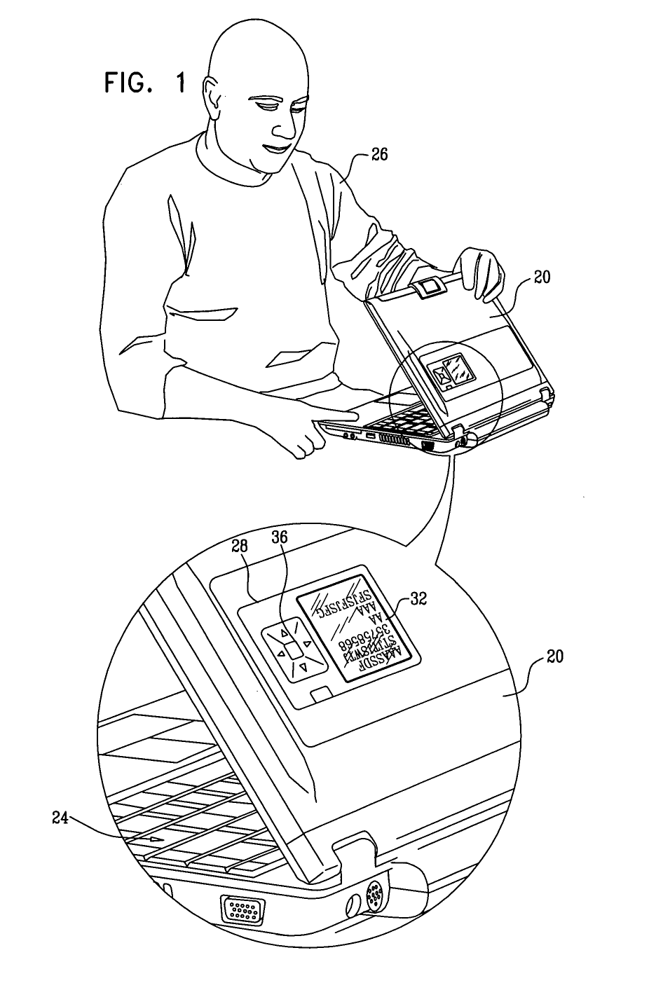

FIG. 1 is a schematic, pictorial illustration of a computer 20 that includes an auxiliary display module 28, in accordance with an embodiment of the present invention. Computer 20 may comprise a laptop, notebook or tablet computer, or any other suitable computing platform. The computer comprises a primary keyboard 24 and a primary display (hidden in the figure), using which a user 26 normally interacts with the computer.

Computer 20 further comprises an auxiliary display module 28, which is used for displaying information to the user when the computer is switched off. In some embodiments, the primary keyboard and primary display are fitted in the interior of the computer's enclosure, and the auxiliary module is fitted in an external surface of the enclosure. For example, in the exemplary configuration of FIG. 1, computer 20 comprises a laptop computer with a folding covet, and module 28 is fitted on the outside of the cover. Thus, the user can view and manipulate the auxiliary information displayed by module 28 when the laptop cover is closed, i.e., when the laptop is switched off or hibernating.

In the context of the present patent application and in the claims, the term “switched off” is used to describe various possible operational modes and states, in which most functions of the computer are disabled, usually in order to conserve battery power. Switched off states may comprise, for example, states or modes in which the computer is turned off, in sleep mode, hibernating or standing by. Typically but not necessarily, the primary display of the computer is disabled when the computer is in these states.

Module 28 comprises an auxiliary display 32, on which the auxiliary information is displayed. In some embodiments, module 28 also comprises an auxiliary keypad 36, using which the user can scroll, select or otherwise manipulate the displayed auxiliary information. The keypad normally comprises a small number of keys, such as arrow keys and/or an “enter” key.

Module 28 may have any desired shape, functionality or configuration, such as the modules described in the Background references, cited above. For example, as shown in the Fuller reference cited above, the auxiliary display module may comprise a laptop-edge display, with or without an auxiliary keypad.

Although module 28 is typically used when computer 20 is switched-off, in some embodiments the auxiliary module may operate in parallel to the main display and display the auxiliary information when the computer is active.

When module 28 is not in use, such as when no key of keypad 36 is pressed for a certain time period, the module is deactivated in order to conserve energy. When module 28 is mounted on the outside of computer 20, such as in the configuration of FIG. 1, deactivation of the auxiliary module also serves as a security measure. Since the auxiliary information is hidden when module 28 is deactivated, unauthorized viewing and manipulation of the auxiliary information is prevented.

It is possible in principle to re-activate module 28 using auxiliary keypad 36. However, when computer 20 is stored or carried, the keys of keypad 36 may be pressed accidentally. If the auxiliary module were to be activated using keypad 36, the module could be activated inadvertently by such accidental key presses, resulting in unnecessary energy loss and exposure of possibly private information.

Thus, in accordance with some embodiments of the present invention, user 26 activates module 28 using primary keyboard 24. In order to activate module 28, the user enters a pre-programmed activation code using the primary keyboard. The activation code may comprise any desired sequence of keys of keyboard 24, such as an alphanumerical password, or even a single key.

The activation code may be stored in a memory of the embedded controller or in a memory of the auxiliary display module. In some embodiments, the activation code can be set or changed using the setup menus of Basic Input/Output System (BIOS) of computer 20, or using a dedicated software program running on the main computer CPU.

Note that when computer 20 comprises a folding cover, the user may need to open the cover in order to access the primary keyboard before entering the activation code.

Activating the auxiliary module using the internal primary keyboard, as opposed to activation using the external auxiliary keypad, is not sensitive to accidental key presses. Furthermore, since keyboard 24 has a much larger number of keys in comparison with keypad 36, activation codes or passwords having any length and complexity can be defined, offering a high degree of security.

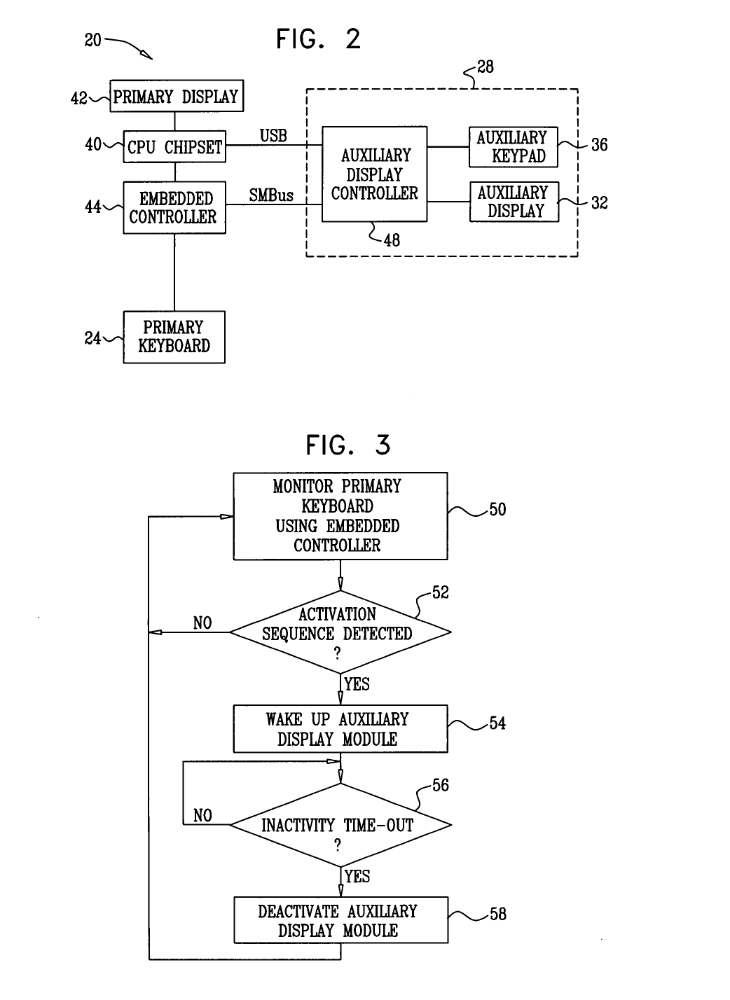

FIG. 2 is a block diagram that schematically illustrates computer 20, in accordance with an embodiment of the present invention. Computer 20 comprises a CPU chipset 40, which comprises the CPU of the computer, a graphic controller for driving a primary display 42, memory devices and additional hardware, as is known in the art.

Computer 20 further comprises an embedded controller 44, also referred to herein as an activation controller, which manages the different operational states of the computer. The embedded controller activates and deactivates different components or functions of computer 20, depending on the desired operational state of the computer. For example, when computer 20 is switched off (e.g., turned off or in hibernation), embedded controller 44 typically deactivates CPU chipset 40 and primary display 42, in order to conserve battery power.

Embedded controller 44 is active at all times, regardless of the operational mode or state of the computer, even when the computer is turned off from the user's point of view. When the computer is turned off, the embedded controller may operate in a power-saving mode. In particular, the embedded controller continuously scans or otherwise monitors primary keyboard 24. Thus, the embedded controller is able to detect the activation code entered by the user, irrespective of whether the computer is active or inactive. Upon detecting the activation code, embedded controller 44 activates the auxiliary display module. In alternative embodiments, the auxiliary display module is able to monitor the main keyboard independently of the embedded controller.

Auxiliary display module 28 comprises an auxiliary display controller 48. Controller 48 accepts the auxiliary information for display from CPU chipset 40 and displays the information on auxiliary display 32. When module 28 comprises auxiliary pad 36, controller 48 accepts user input from keypad 36 and uses this input for scrolling or otherwise manipulating the displayed auxiliary information. In some embodiments, auxiliary display controller 48 is connected to the CPU chipset 40 using a Universal Serial Bus (USB) interface.

Alternatively, any other suitable interface, such as a Bluetooth™, WiFi® or ZigBee® link, can be used for connecting controller 48 with chipset 40.

Auxiliary display controller 48 is connected to embedded controller 44 by a System Management Bus (SMBus) interface or other suitable interface, using which the embedded controller can activate the auxiliary module. In some embodiments, the embedded controller is responsible for deactivating module 28 using the SMBus interface. Typically, however, auxiliary display controller 48 deactivates module 28 when appropriate, and updates the embedded controller with the status of the module.

Additional components of computer 20 that are not essential to the understanding of the methods and systems described herein are omitted from FIG. 2 for the sake of conceptual clarity. For example, the SMBus connecting the embedded controller and the auxiliary display controller may also serve additional components. As another example, CPU chipset 40 may comprise additional components and functions.

Typically, embedded controller 44 and auxiliary display controller 48 comprise general-purpose processors, which are programmed in software to carry out the functions described herein. The software may be downloaded to the processors in electronic form, over a network, for example, or it may alternatively be supplied to the processors on tangible media, such as CD-ROM.

### Activation Method Description

FIG. 3 is a flow chart that schematically illustrates a method for activation of auxiliary display module 28, in accordance with an embodiment of the present invention. The computer is assumed to be in a switched-off state, e.g., turned off, in standby or hibernating.

The method begins with embedded controller 44 monitoring primary keyboard 24, at a keyboard monitoring step 50. The embedded controller continuously examines the input from the primary keyboard and attempts to detect the pre-programmed activation code of the auxiliary display module, at a keyboard checking step 52. As long as the activation code is not detected, the method loops back to keyboard monitoring step 50 above, and the embedded controller continues to monitor the primary keyboard.

When user 26 enters the activation code using primary keyboard 24, i.e., when the output of keyboard 24 matches the activation code, embedded controller 44 detects the code and activates auxiliary display module 28, at an activation step 54. Typically, the embedded controller sends an activation message to auxiliary display controller 48 over the SMBus interface. In response to the activation message, controller 48 activates auxiliary display 32 and displays the auxiliary information to user 26.

In some embodiments, controller 48 monitors the activity of auxiliary keypad 36 and measures the time elapsed from the last key press. When controller 48 determines that a pre-determined inactivity time-out elapses, at an inactivity checking step 56, controller 48 deactivates module 28, at a deactivation step 58. The method then loops back to keyboard monitoring step 50 above, and embedded controller 44 continues to attempt detecting the activation code. Alternatively, module 28 can be deactivated, either by controller 48 or by controller 44, when the battery is low, in response to a user command (e.g., by pressing a dedicated button monitored by the auxiliary display controller, in accordance with a predetermined user configuration, and/or based on any other suitable condition.

Although the embodiments described herein mainly refer to the activation of an auxiliary display module fitted in the cover of a laptop computer, the principles of the present invention can also be used for activating other types of auxiliary modules that are connected to other types of host computers.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A computing apparatus, comprising:
a primary keyboard and a primary display, which are respectively arranged to accept input from a user and to display information to the user;
an auxiliary display, which is arranged to display auxiliary information to the user when the apparatus is in a switched-off operational state, and to hide the auxiliary information when deactivated; and
an activation controller, which is arranged to monitor the primary keyboard when the auxiliary display is deactivated, to detect an activation code comprising one or more keystrokes entered using the primary keyboard, and to activate the auxiliary display responsively to detecting the activation code.

2. The apparatus according to claim 1, and comprising an enclosure having an interior and an external surface, wherein the primary keyboard and the primary display are fitted in the interior of the enclosure and wherein the auxiliary display is fitted on the external surface of the enclosure.

3. The apparatus according to claim 2, wherein the enclosure comprises a folding cover, and wherein the auxiliary display is fitted on the external surface of the cover.

4. The apparatus according to claim 1, wherein the activation controller is arranged to monitor the primary keyboard irrespective of whether the apparatus is in the switched-off operational state.

5. The apparatus according to claim 1, and comprising a central processing unit (CPU) and an auxiliary display controller, wherein the CPU is arranged to produce the auxiliary information and to provide the auxiliary information to the auxiliary display controller, and wherein the activation controller is arranged to disable the CPU when the apparatus is in the switched-off operational state.

6. The apparatus according to claim 5, wherein the activation controller and the auxiliary display controller are arranged to communicate with one another over a communication interface, and wherein the activation controller is arranged to activate the auxiliary display by sending an activation message to the auxiliary display controller over the communication interface.

7. The apparatus according to claim 6, wherein the communication interface comprises a System Management Bus (SMBus).

8. The apparatus according to claim 1, wherein the activation code comprises an alphanumerical password.

9. A computing method, comprising:
in a computer that includes a primary keyboard, a primary display and an auxiliary display, displaying auxiliary information on the auxiliary display when the computer is in a switched-off operational state and hiding the auxiliary information when the auxiliary display is deactivated;
monitoring the primary keyboard when the auxiliary display is deactivated;
detecting an activation code comprising one or more keystrokes entered using the primary keyboard; and
activating the auxiliary display responsively to detecting the activation code so as to display the auxiliary information.

10. The method according to claim 9, wherein the computer is packaged in an enclosure having an interior and an external surface, wherein the primary keyboard and the primary display are fitted in the interior of the enclosure and wherein the auxiliary display is fitted on the external surface of the enclosure.

11. The method according to claim 10, wherein the enclosure comprises a folding cover, and wherein the auxiliary display is fitted on the external surface of the cover.

12. The method according to claim 9, wherein monitoring the primary keyboard comprises monitoring the keyboard irrespective of whether the computer is in the switched-off operational state.

13. The method according to claim 9, wherein the computer comprises an activation controller and an auxiliary display controller that communicate over a communication interface, and wherein monitoring the primary keyboard and detecting the activation code comprises scanning the primary keyboard by the activation controller, and wherein activating the auxiliary display comprises sending an activation message from the activation controller to the auxiliary display controller over the communication interface.

14. The method according to claim 13, wherein the communication interface comprises a System Management Bus (SMBus).

15. The method according to claim 9, wherein the activation code comprises an alphanumerical password.

16. A computer software product used in a computer that includes a primary keyboard, a primary display and an auxiliary display, the product comprising a computer-readable medium, in which program instructions are stored, which instructions, when read by the computer, cause the computer to display auxiliary information on the auxiliary display when the computer is in a switched-off operational state, to hide the auxiliary information when the auxiliary display is deactivated, to monitor the primary keyboard when the auxiliary display is deactivated, to detect an activation code comprising one or more keystrokes entered using the primary keyboard, and to activate the auxiliary display responsively to detecting the activation code.

17. The product according to claim 16, wherein the computer is packaged in an enclosure having an interior and an external surface, wherein the primary keyboard and the primary display are fitted in the interior of the enclosure and wherein the auxiliary display is fitted on the external surface of the enclosure.

18. The product according to claim 17, wherein the enclosure comprises a folding cover, and wherein the auxiliary display is fitted on the external surface of the cover.

19. The product according to claim 16, wherein the computer comprises an activation controller and an auxiliary display controller that communicate over a communication interface, and wherein the instructions cause the activation processor to monitor the primary keyboard, to detect the activation code and to send an activation message to the auxiliary display controller over the communication interface in order to activate the auxiliary display.
